(19) United States
(12) Patent Application Publication
(10) Pub. No.: US 2014/0149258 A1
(43) Pub. Date: May 29, 2014

(54) SYSTEMS, METHODS AND APPARATUSES FOR AGGREGATING AND DISPLAYING CONTENT

(71) Applicant: Joyce Ann Fyfe, Cleveland, OH (US)

(72) Inventor: Joyce Ann Fyfe, Cleveland, OH (US)

(21) Appl. No.: 14/092,463

(22) Filed: Nov. 27, 2013

Related U.S. Application Data
(60) Provisional application No. 61/731,188, filed on Nov. 29, 2012.

(51) Int. Cl. G06Q 30/06

(52) U.S. Cl. CPC G06Q 30/0631; G06Q 30/0627
USPC 705/26.63; 705/26.7

(57) ABSTRACT

Systems and methods are provided for identifying, extracting, mapping, and updating product information. Further, systems and methods are provided to view the product information on a portable computing device or a personal computing device. On the portable computing device, the display of product information is made available either through a dedicated mobile application or through a website link. On a personal computing device, the display of product information is made available either through a desktop application or through a website link. The product information is updated on an ongoing basis to provide current product information to the end user.

### FIELD OF THE INVENTION

The general inventive concepts relate to aggregating and displaying diverse content and, more particularly, to systems, methods, and apparatuses for aggregating and displaying print and electronic content on personal and portable computing devices.

### BACKGROUND

Content distribution and advertising has evolved from utilizing pamphlets and booklets to employing sophisticated print and electronic channels. In the print medium, advertisers and manufacturers routinely spend significant monetary resources to reach out to customers via high impact ads. For example, it is common for advertisers and manufacturers of beauty products to purchase full page ads in fashion and beauty magazines. Similarly, in the electronic medium, advertisers and manufacturers use a combination of contextual and non-contextual ads to reach out to customers. For instance, display ads, pop-up ads, and email newsletter ads are popular sources of online advertising. The goal of many of these ads is to motivate the customer to visit a brick-and-mortar store which sells the advertised product so that the customer may purchase the product at the store.

Editorials, on the other hand, serve as an additional source of customer outreach. It is common for magazines, websites, blogs and other publications to opine on products and services through editorials. An editorial provides the opportunity for an author to write an article on behalf of a publisher or an editor, and to provide the customer with advice and feedback regarding products or services. Customers look to editorials to provide in-depth reviews and impartial advice on the products and services of interest. As with the traditional context distribution and advertising channels, one goal of the editorials would be to drive the customer to a store. But more frequently, the primary goal of the editorials tends to focus on educating the customer on various product and service choices available in the marketplace, including the relative strengths and weaknesses of said choices.

However, while print advertising, electronic media advertising, or editorial exposure, can motivate the customer to visit a store, the customer experience within the store is typically not controlled by the advertiser or the manufacturer. For example, once a customer visits a store for reviewing and purchasing a product, if the store personnel are not aware of the product being sought by the customer, the advertiser or manufacturer can do little to control the customer's purchase experience. This problem is particularly pervasive in stores that carry several manufacturers' product lines for a single category of product. Brick and mortar stores often lack an efficient mechanism for making sales personnel aware of the information regarding each manufacturer's product line, which is presented to customers before they visit the store. For example, a customer may visit a brick and mortar store hoping to purchase a product he or she saw modeled by a popular celebrity in a print magazine, or featured in a magazine article. If the store personnel is not aware of the product or the endorsement, the store may lose the opportunity for a sale and the customer may leave the store frustrated at the store personnel's lack of knowledge. Therefore, advertisers and manufacturers alike would like to better educate the store's sales staff regarding product information presented to consumers outside of the store and enable a smooth product purchase experience for the customer. Similarly, advertisers and manufacturers would also like to educate the store personnel regarding their products' differentiation as compared to the competition, and equip them with the proper tools required to provide quality service to the customer and to make a sale.

To achieve the above-mentioned goals, advertisers and manufacturers need a medium to aggregate content from the various print campaigns, electronic ad campaigns, and editorials, and deliver them to the stores in an easy-to-use format. Once delivered, advertisers and manufacturers will further need the medium to enable the store personnel to quickly and efficiently become knowledgeable of the information that has been presented to customers regarding the product and to ultimately make a sale, as well as serve as an educational tool to understand the product specifications and its differentiation from other products.

In view of the above, there is an unmet need for systems, methods and apparatuses for aggregating and displaying print and electronic content on personal and portable computing devices to be used in retail stores.

### BRIEF SUMMARY

The general inventive concepts contemplate systems, methods, and apparatuses for aggregating and displaying print and electronic content on present day and future personal and portable computing devices. By way of example, to illustrate various aspects of the general inventive concepts, several exemplary embodiments of systems methods and/or apparatuses are disclosed herein.

Systems, methods, and apparatuses, according to one exemplary embodiment, provide for choosing a product source, and identifying and extracting product content from the source. Further, the systems, methods, and apparatuses provide for mapping the product content to one or more stores displaying and/or selling the product.

Systems, methods, and apparatuses, according to one exemplary embodiment, provide for creating and updating a database with product content and store information. The product content and store information may be categorized such as to allow for its search and retrieval in multiple ways. For example, a product may be searched by choosing a store displaying and/or selling the product. As a further example, a product may be searched by a celebrity endorsing the product. As yet further examples, a product may be searched by category or characteristic.

Systems, methods, and apparatuses, according to one exemplary embodiment, allow downloading a product display application to a portable computing device. The downloading system comprises a server and a portable computing device. The product display application is downloaded to the portable computing device through an online, internet, consumer decision or transaction to download the app from an app store from the server in response to the portable computing device requesting said application. The product display application is further configured to be updated on a periodic basis via an update from the server, either through push or pull of the update from the server.

The systems, methods, and apparatuses of the invention may be advantageously used in connection with the sale of nearly any type of product. One product category as to which the systems, methods, and apparatuses of the invention are particularly advantageous is beauty products. The inventive systems, methods, and apparatuses, sales may be used to educate sales personnel and customers, and thus, advantageously bridge the gap between customers' observations and awareness of information regarding a product which is presented to customers outside of the store, and store personnel's knowledge of such information.

Additional features and advantages will be set forth in part in the description that follows, and in part will be obvious from the description, or may be learned by practice of the embodiments disclosed herein. The objects and advantages of the embodiments disclosed herein will be realized and attained by means of the elements and combinations particularly pointed out in the specification. It is to be understood that both the foregoing brief summary and the following detailed description are exemplary and explanatory only and are not restrictive of the embodiments disclosed herein or as claimed.

### BRIEF DESCRIPTION OF THE DRAWINGS

The accompanying drawings, which are incorporated in and constitute a part of this specification, illustrate some embodiments disclosed herein, and together with the description, serve to explain principles of the embodiments disclosed herein.

FIG. 1 shows a diagram of an exemplary system environment for identifying, extracting, mapping, and updating product information from a source, in accordance with the embodiments of the present disclosure.

FIG. 2 shows the extracting step of FIG. 1 in further detail.

FIG. 3 shows the mapping step of FIG. 1 in further detail

FIG. 4 shows the updating step of FIG. 1 in further detail

FIG. 5 depicts a flow diagram of an exemplary system environment for electronically delivering content for a product display application over the internet.

FIG. 6 shows an exemplary home screen of the product display application.

FIG. 7 shows an exemplary search screen of the product display application.

FIG. 8 shows an exemplary search results screen of the product display application.

FIG. 9 shows an exemplary search screen of the product display application.

FIG. 10 shows an exemplary search results screen of the product display application.

FIG. 11 shows an exemplary product detail screen in the product display application.

FIG. 12 shows an exemplary product detail screen in the product display application.

FIG. 13 shows an exemplary product detail screen in the product display application.

FIG. 14 depicts a flow diagram of an exemplary system environment for electronically delivering and updating content for a product display application over the internet.

### DETAILED DESCRIPTION

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise. All publications, patent applications, patents, and other references mentioned herein are incorporated by reference in their entirety.

The following are definitions of exemplary terms used throughout the disclosure. Both singular and plural forms of all terms fall within each meaning:

“Software” or “computer program” as used herein includes, but is not limited to, one or more computer or machine readable and/or executable instructions that cause a computer, microprocessor, logic circuit, or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, an app, a function call, a servlet, an applet, instructions stored in a memory or any other computer readable medium (transitory or non-transitory), part of an operating system or other type of executable instructions. It will be appreciated by one of ordinary skill in the art that the form of software is dependent on, for example, requirements of a desired application, the environment it runs on, and/or the desires of a designer/programmer or the like.

“Mobile Application” or “Mobile App” or “App” as used herein, includes, but is not limited to, applications that run on smart phones, tablet computers, and other mobile devices. The terms “Mobile Application” or “Mobile App” or “App” can be used synonymously with “software”. Mobile applications allow users to connect to services which are traditionally available on the desktop or notebook platforms. Typically, these services access the internet or intranet or cellular or wireless fidelity (Wi-Fi) networks, to access, retrieve, transmit and share data.

“Computer” or “processing unit” as used herein includes, but is not limited to, any programmed or programmable electronic device, microprocessor, logic circuit, that can store, retrieve, and process data.

A “Network” as used herein, includes, but is not limited to, a collection of hardware components and computers or machines interconnected by communication channels that allow sharing of resources and information, including without limitation, the worldwide web or internet. The Network used herein and with respect to this invention includes both wireless and “wired” networks.

A “Web browser” as used herein, includes, but is not limited to, a software for retrieving and presenting information resources on the World Wide Web. An information resource may be a web page, an image, a video, or any other type of electronic content.

A “Server” as used herein, includes, but is not limited to, a computer or a machine or a device on a network that manages network resources. The general term “Server” may include specific types of servers, such as a File Server (a computer and storage device dedicated to storing files), Print Server (a computer that manages one or more printers), a Network Server (a computer that manages network traffic), and a Database Server (a computer system that processes database queries). Although servers are frequently dedicated to performing only server tasks, certain multiprocessing operating systems allow a server to manage other non-server related resources.

A “Web Server” as used herein, includes, but is not limited to, a server which serves content to a Web browser by loading a file from a disk and serving it across a network to a user's Web browser, typically using a hyper text transfer protocol (HTTP).

Now, with particular reference to the drawings, exemplary embodiments of the invention are described below.

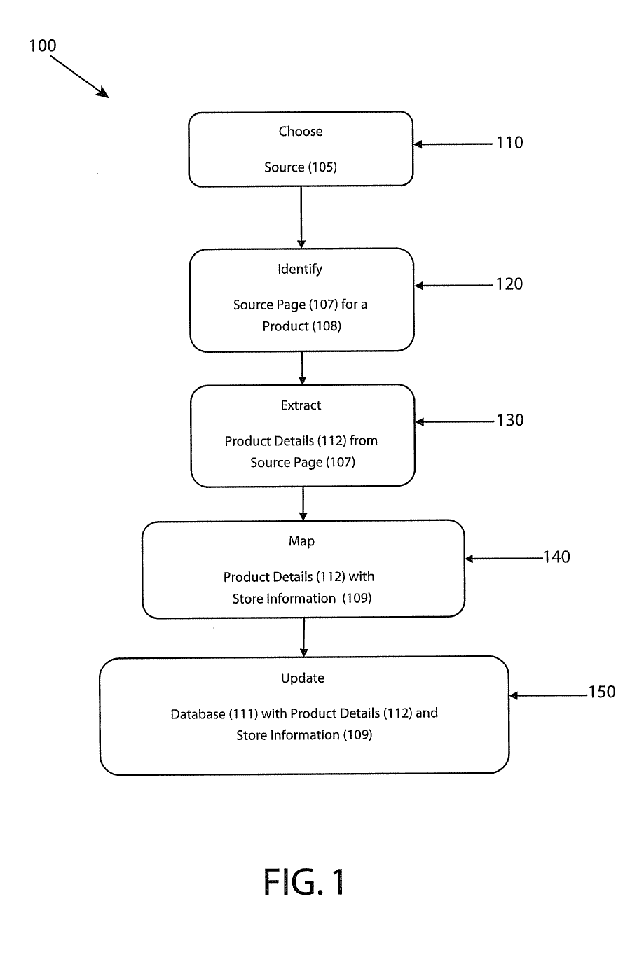

FIG. 1 depicts a flow diagram of an exemplary environment 100 for aggregating and processing content from a source 105. One embodiment in the present application is described with reference to a magazine as the source. Specifically, one embodiment of the present invention will be described in the figures with reference to choosing, identifying, extracting, mapping, and updating product advertisements from a magazine.

One of ordinary skill in the art will appreciate that any suitable source may be implemented in the present invention. Exemplary sources comprise Facebook® pages, internet blogs, content on the internet, content in print media, movies, television, radio, conferences, private events, previews (e.g., fashion shows), competitions, news articles or programs, and any other source which permits for content available within the source to be aggregated and displayed in accordance with principles of the present invention.

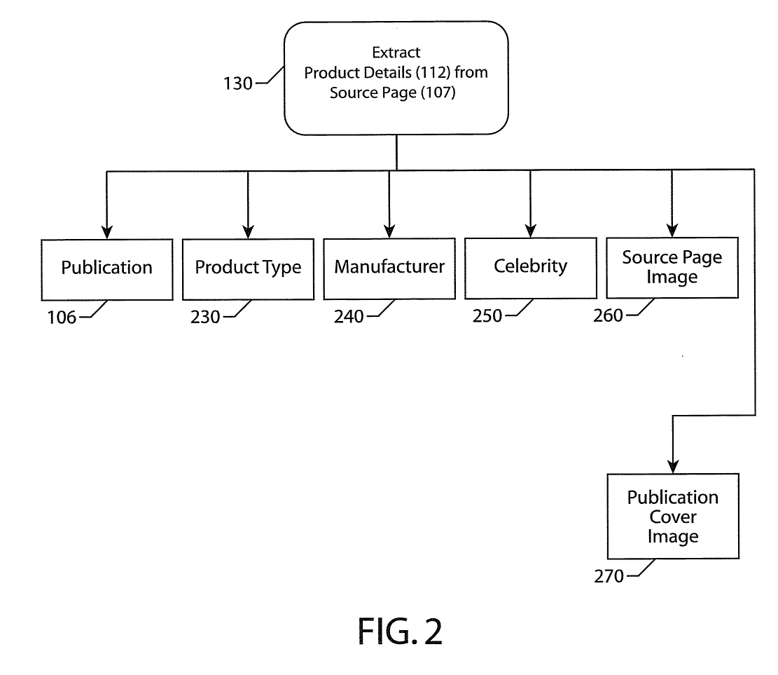

With further reference to FIG. 1, at step 110, a particular magazine 106 (not shown) is chosen. At step 120, a particular source page 107 within the magazine 106 is identified. The source page 107 displays a product 108. At step 130, specific details 112 (not shown) of the product 108 are extracted from source page 107. At step 140, product details 112 are mapped with one or more stores 109 which display and/or sell the product 108. Mapping as used herein means identifying and connecting product details 112 with specific stores at which a particular product is displayed or is offered for sale. At step 150, product details 112 and the associated store information 109 is stored in a database 111. Steps 130, 140, and 150 are described in further detail in FIGS. 2, 3, and 4 respectively.

With reference to FIG. 2, step 130 of FIG. 1 is described in further detail. After a particular magazine 106 and a particular product of interest 108 are identified at step 120, the logic flow of the invention moves to step 130, where certain product details 112 of the product 108 are extracted from the source page 107. For instance, if the product 108 is a beauty product endorsed by a celebrity 250, specific product details such as the product type 230, product manufacturer name 240, the celebrity name 250, and the name of the magazine 106 are extracted from the source page 107. Additionally, an image 260 of the source page 107, and an image 270 of the cover of magazine 106 are also extracted. One of ordinary skill in the art will appreciate that any other type of product details may be extracted. For example, there could be additional types of product details such as product identifiers which may be extracted. Further, any of the existing enumerated product details (e.g. celebrity 250) are merely exemplary and are not necessary to practice the invention. In another embodiment, the user has the option to choose which product details are extracted. However, one of ordinary skill in the art will also appreciate that only such product details which are extracted in step 130 are carried over to be implemented as part of the other features in this invention. However, additional extractions of product details from previously extracted sources at a later time or a second iteration of the extraction step 130 may be used as part of this invention.

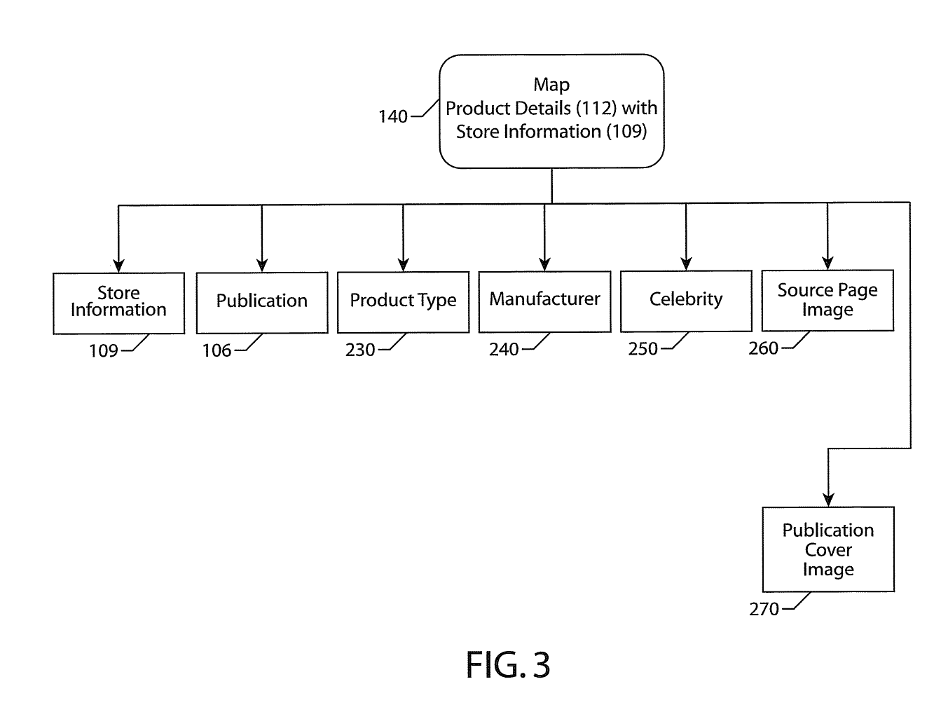

With reference to FIG. 3, step 140 of FIG. 1 is described in further detail. Once product details 112 are extracted from the source page 107 at step 130, said product details 112 are tagged with one or more stores 109 which display and/or sell the product 108. For instance, if product 108 is sold in retail stores Macy's and Nordstrom's, at step 140, product details 112 will be mapped to said stores 109.

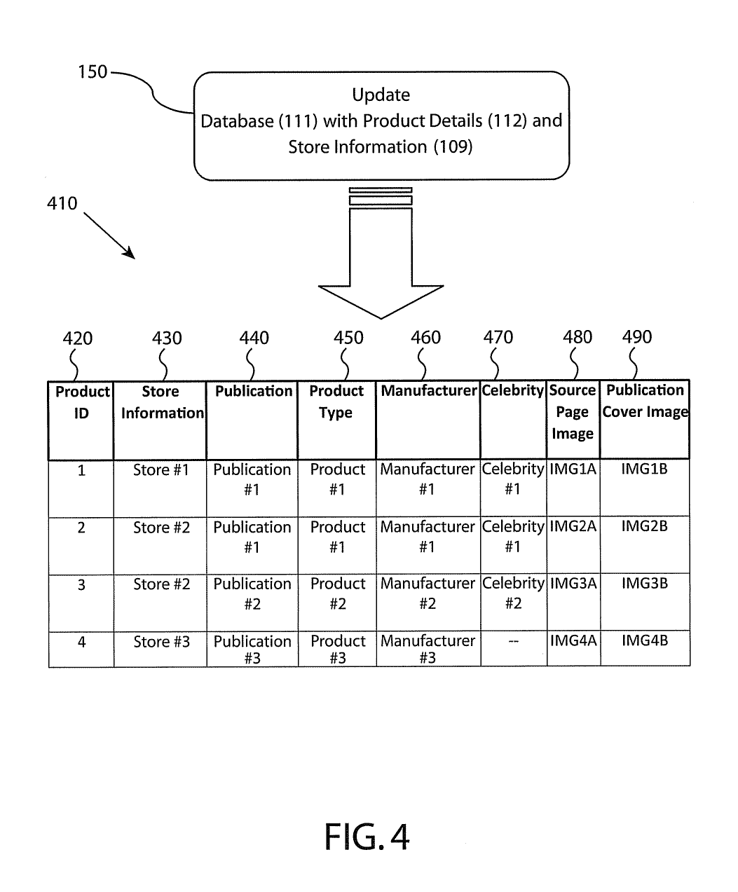

With reference to FIG. 4, step 150 of FIG. 1 is described in further detail. Once the product details 112 and the associated store(s) 109 are mapped, all of this information is entered and stored into a database 111. This can be done automatically or manually. Database 111 may be any commercially available or custom developed database capable of storing, processing, and updating store information 109 and product details 112. For instance, an Oracle® database, or a MS SQL® database, or an MS Access® database could be utilized for this purpose. Within database 111, store information 109 and product details 112 are stored within a table 410. As shown in FIG. 4, table 410 hosts the store information 109 in column 430, the magazine information 106 in column 440, product type information 230 in column 450, product manufacturer name 240 in column 460, celebrity 250 information in column 470, source page image 260 in column 480, and magazine cover image 270 in column 490. Additionally, each product is also associated with a product id 420. Product id 420 acts as an unique identifier for each product 108 with reference to a store 109. If a single product is displayed and/or sold in more than one store, said product will be represented with multiple product ids 420 to help distinguish various stores displaying and/or selling the product 108. In this fashion, information relating to one or more products 108 is entered in the database 111. However, one of ordinary skill in the art will recognize that the product id or any other type of identifier need not be store-specific and such implementation is only one embodiment of the present invention. In other embodiments, the product id may be configured such that a single product id is associated with multiple stores. Further, while the disclosed embodiment is provided with a database having a majority of the information populated, a majority of all columns and rows do not have to be populated for the present invention to operate. Further, many data places may be empty in the database during its operation. For instance, in row #4, the Celebrity column 470 is not populated with any value.

Although the implementation of database 111 is shown with reference to a table 410, any implementation of the database 111 and table 410 consistent with the spirit of this invention may be utilized. For example, the database 111 and table 410 may exist not as a relations database model, but as an object oriented model. In an object oriented model, the database 111 and table 410 may be represented using types, objects, functions and properties known in the art.

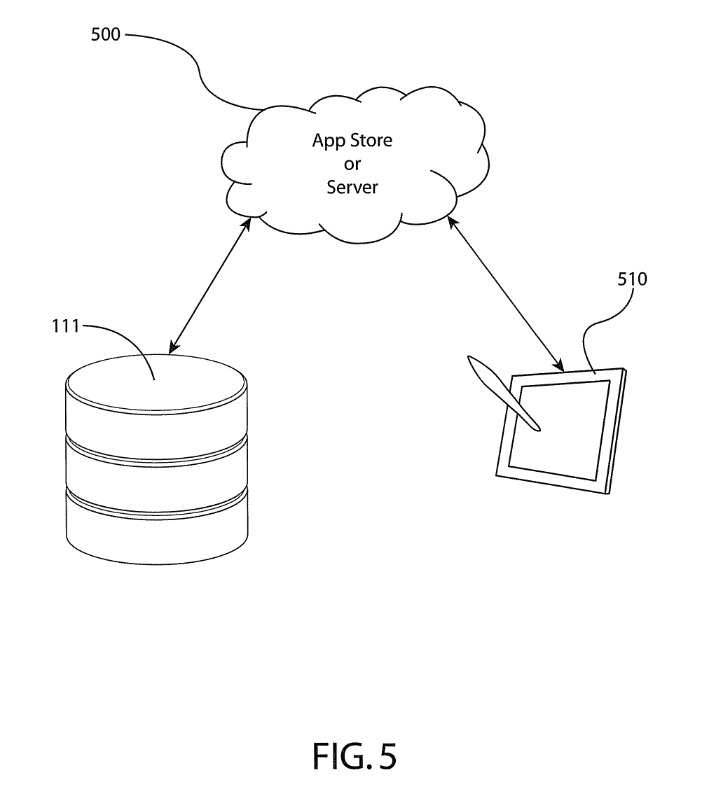

Reference will now be made to FIG. 5. Once the product details 112 and the associated store(s) 109 are stored in database 111, the information in database 111 is available to a device for display. For the purpose of display, a portable computing device 510 may be used in the preferred embodiment. Although a portable computing device 510 is utilized to illustrate the preferred embodiment, the general inventive concepts could be readily extended to a personal computer (PC) or other relatively fixed console computers. For example, the product details 112 and the associated store information 109 may be delivered to stores via the web over a network to be displayed on a desktop or fixed console terminal through a website.

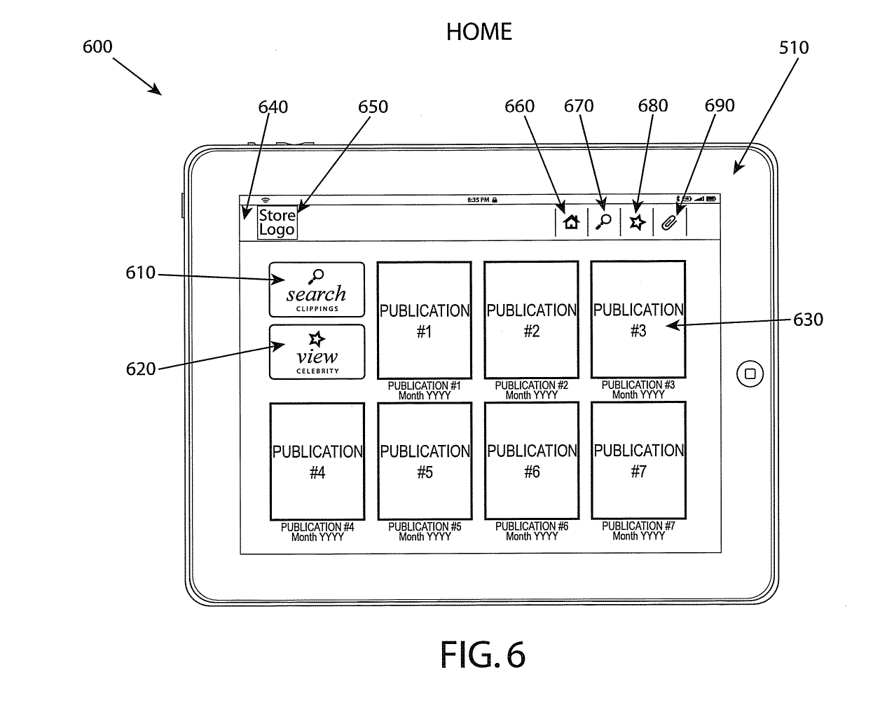

In the example of a store 109 displaying and/or selling the product 108, information regarding the product 108 that is stored in database 111 will need to be downloaded and displayed within the store 109. To this end, a portable computing device 510 may either be equipped with a product display application 640 (shown in FIG. 6) or be configured to display product information via the device's native web browser (not shown). In one embodiment, a product display app is a mobile application installed on the portable computing device 510, such as an Apple iPad®. In another embodiment, the product display app is a shortcut to a website installed on the portable computing device 510. In either case, as an initial matter, a request for the information in database 111 is sent from the portable computing device 510 to an application store (e.g. Apple® App Store) or a web server 500. In one exemplary embodiment, the information in database 111 is uploaded to the store/server 500 prior to said request. In another embodiment, information in database 111 is uploaded to the store/server after said request. Once the store/server 500 receives the request for information, information is extracted from either the store/server 500 (in instances where store/server 500 is updated prior to request) or from the database 111 through the store/server 500 (in instances where store/server 500 is updated after request) and passed back to the portable computing device 510 and the product display app 640. Once the requested information is populated in the portable computing device 510 and the product display app 640, it is then ready to be viewed through the product display app 640.

Referring now to FIG. 6, an exemplary home screen 600 of the product display app 640 is shown. Home screen 600 comprises a header with a logo 650 of store 109, a home icon 660, a search icon 670, a favorite icon 680, and a clip icon 690. Selecting the home icon 660 directs the user 695 (not shown) of the app 640 to return to the home screen 600. Selecting the search icon 670 allows user 695 to search for product 108 or any other products in the app 640. Selecting the favorite icon 680 allows user 695 to mark any detail from the product details 112 as a favorite within the app 640. For example, user 695 may mark a particular product, or a source page, or a magazine as a favorite within the app 640. Further, the favorite icon 680 may also be used by store personnel or any other uses to add the most searched, viewed, requested, or displayed products. The most searched, viewed, requested, or displayed products may either be denoted as such manually by a user (e.g. a store personnel), or be denoted automatically by an algorithm which mines data from the previous accesses to the app 640 to gather said information on searches, views, requests and displays. For example, a “frequently accessed” algorithm may be implemented. Such algorithm would mark the access frequency and access locations of all items in the database and retrieve such information on demand through a user interface. Selecting the clip icon 690 allows user 695 to view various product clippings. Selecting the clip icon 690 may also allow user 695 to view results of a previous or current search. Search icon 610 allows the user 695 to search for product 108 or any other products in the app 640, similar to the functionality provided by search icon 670. View celebrity icon 620 allows the user 695 to view product 108 or any other products in the app 640 that are endorsed by a selected celebrity. Exemplary publications are represented by reference 630. For instance, reference 630 may be a fashion magazine cover with a celebrity and/or a product image. As is typical in fashion magazine covers, reference 630 may include more than one celebrity and/or product image(s), along with text accompanying the celebrity and/or product image(s).

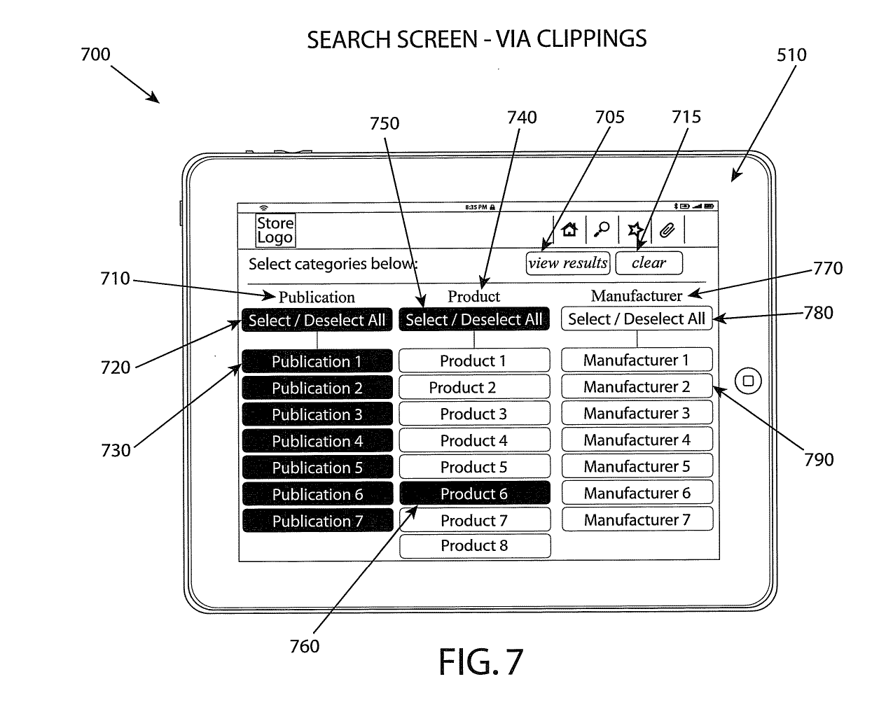

With reference to FIG. 7, if a user 695 selects search 610 or search 670 of FIG. 6, the user 695 is directed to the search screen 700 of FIG. 7. The search screen 700 comprises a publication search criteria 710, a product search criteria 740, and a manufacturer search criteria 770. User 695 may select all publications in the app 640 by selecting icon 720. Similarly, user 695 may de-select all publications by selecting the same icon 720. Alternately, user 695 may select one or more publications 730 individually by tapping one of the Publication icons such as “Publication 5”. Further user 695 may select all products in the app 640 by selecting icon 750. Similarly, user 695 may de-select all products in the app by selecting the same icon 750. Alternately, user 695 may select one or more products 760 individually by tapping one of the Product icons such as “Product 6”. Further user 695 may select all manufacturers in the app 640 by selecting icon 780. Similarly, user 695 may de-select all manufacturers in the app by selecting the same icon 780. Alternately, user 695 may select one or more manufacturers 790 individually by tapping one of the Manufacturer icons such as “Manufacturer 5”. Once the user selects one or more of publication 710, product 740, and manufacturer 770, the user may select view results 705 to view the results of the user's search. At any point in this search, user 695 may select clear icon 715 to clear the selections on the screen 700. One or ordinary skill in the art will appreciate that any of the various details among the product details 112 may be utilized to serve as search criteria, in addition to, or in replacement to the search criteria listed above (e.g. a celebrity name search criteria on screen 700).

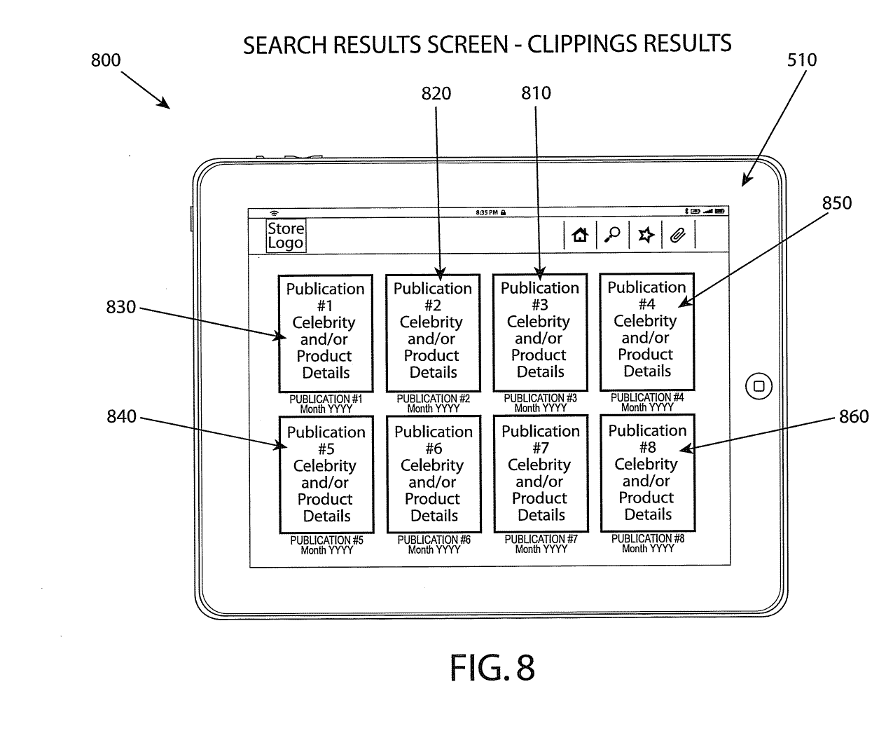

With reference to FIG. 8, if user 695 selects the view results 705 in FIG. 7, user 695 is presented with the search results screen 800 of FIG. 8. In the exemplary search by user 695, if the user selects all publications 710 and product 760 (which may be a lip product) as shown in FIG. 7, screen 800 in FIG. 8 shows the results of said search by displaying several magazines 810 through 860. The search results screen 800 therefore displays all magazines which carry the lip product selected by user 695 in FIG. 7. Additionally, the search results screen 800 also displays the source page images previously captured and stored, as described with reference to FIGS. 1 through 4. Providing the product results on the source page images provides context for the user 695 and helps the user 695 in easily identifying and locating the desired product from the search results screen 800. In addition to the source page image, the search results screen 800 may also comprise the product type information 230, product manufacturer name 240, celebrity information 250, and magazine cover image 270 in column 490.

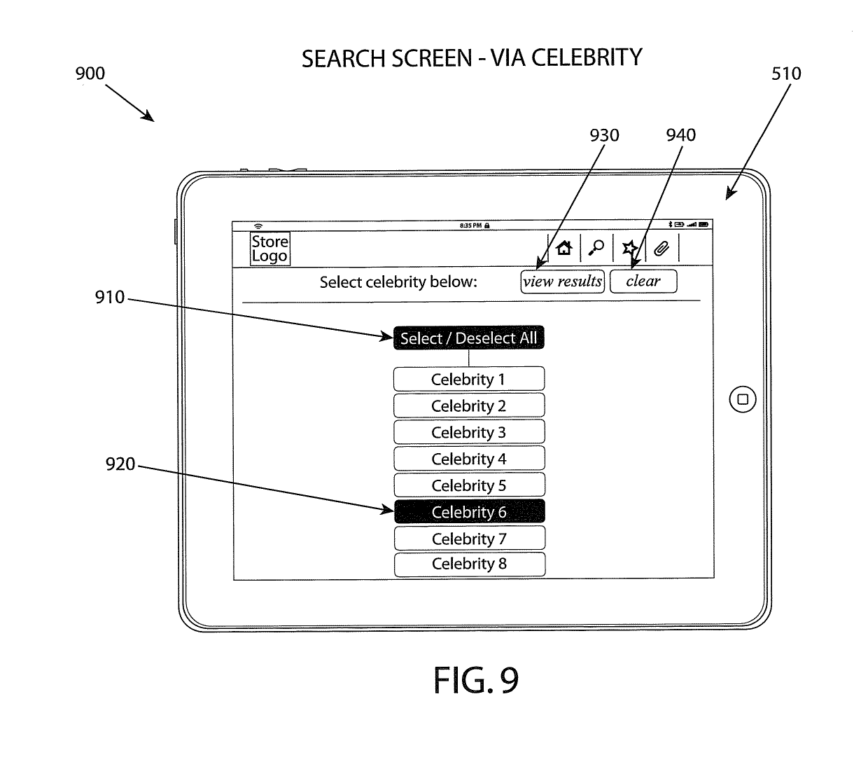

With reference to FIG. 9, if a user 695 selects the celebrity key or bottom 620 of FIG. 6, the user 695 is directed to the search screen 900 of FIG. 9. The search screen 700 comprises a search by celebrity or celebrities. User 695 may either search for a product based on a single celebrity 920 or via selecting all celebrities available in the app 640. User 695 selects icon 910 to either select or de-select all celebrities available in the app 640. Once user 695 selects the desired celebrity or celebrities, user 695 may then select the view results 930 icon to view the results of the search. At any point in this search, user 695 may select clear icon 940 to clear the selections on the screen 900.

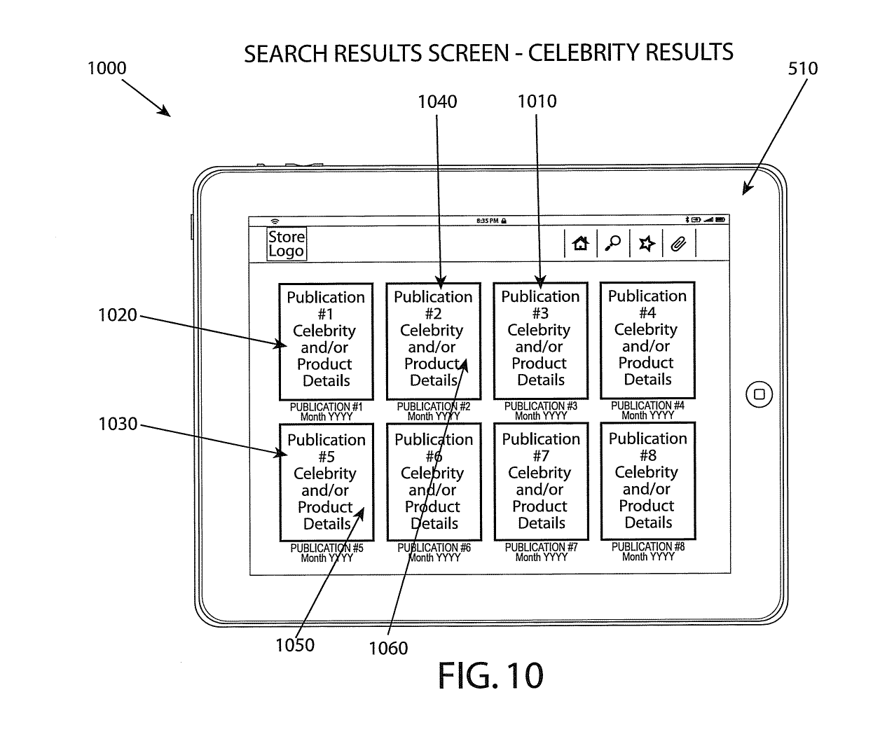

With reference to FIG. 10, if user 695 selects the view results 930 in FIG. 9, user 695 is presented with the search results screen 1000 of FIG. 10. In the exemplary search by user 695, if the user selects all celebrities 910, screen 1000 shows the results of said search by displaying several celebrities 1010 through 1060. The search results screen 1000 therefore displays all celebrities selected by user 695 in FIG. 9. Additionally, the search results screen 1000 also displays the source page images previously captured and stored, as described with reference to FIGS. 1 through 4. Providing the product results on the source page images provides context for the user 695 and helps the user 695 in easily identifying and locating the desired product from the search results screen 1000. In addition to the source page image, the search results screen 1000 may also comprise the product type information 230, product manufacturer name 240, celebrity information 250, and magazine cover image 270 in column 490. Unlike the search results in FIG. 8, the search results in FIG. 10 are celebrity based, and therefore may require the display of celebrity information 250.

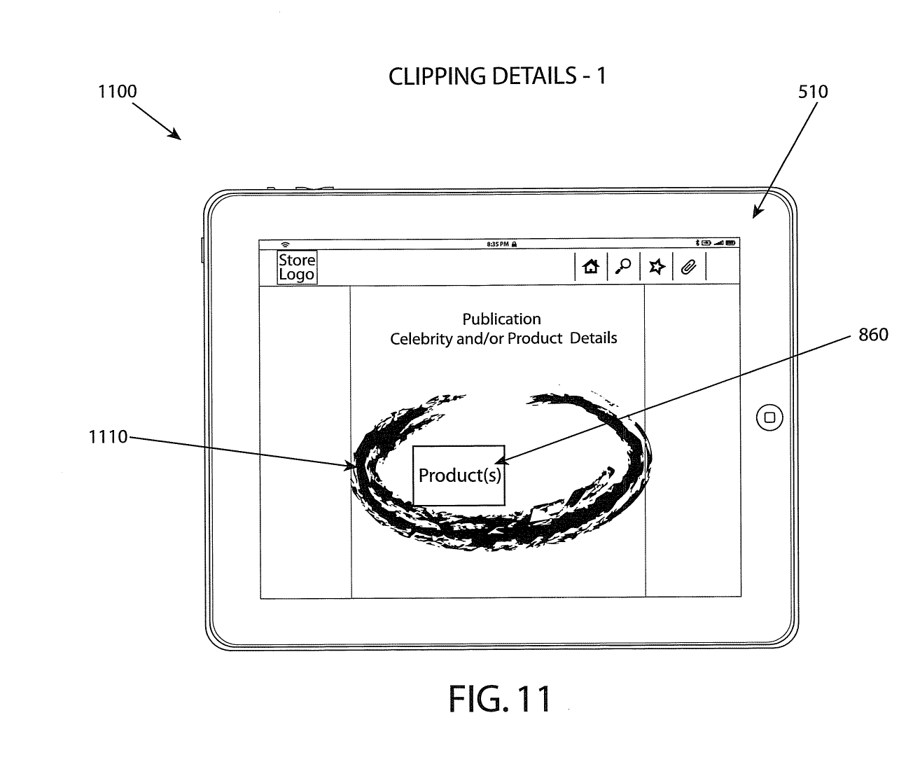

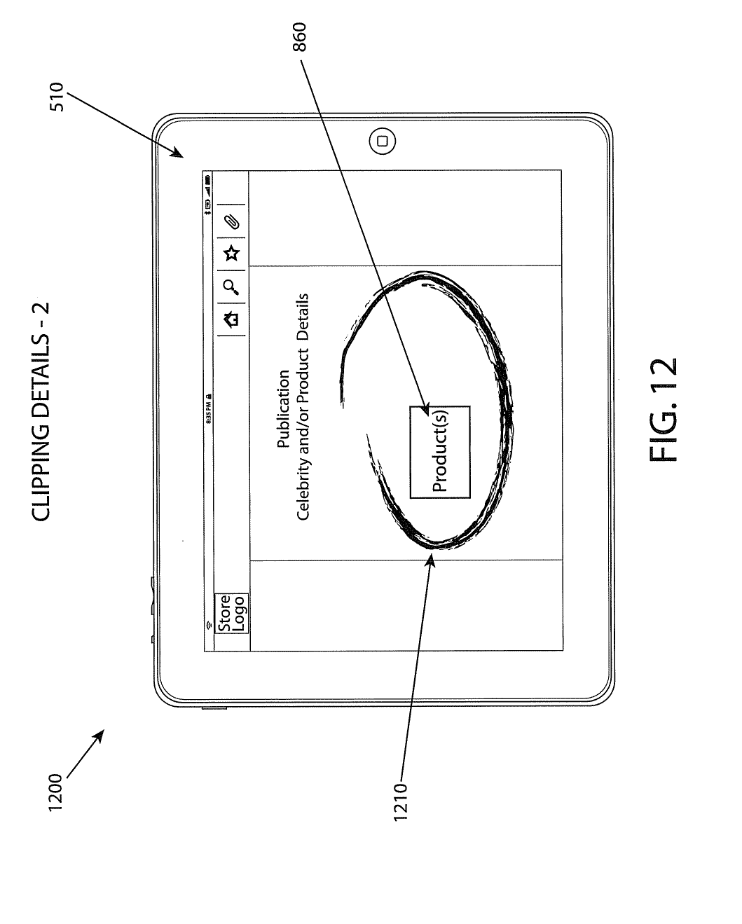

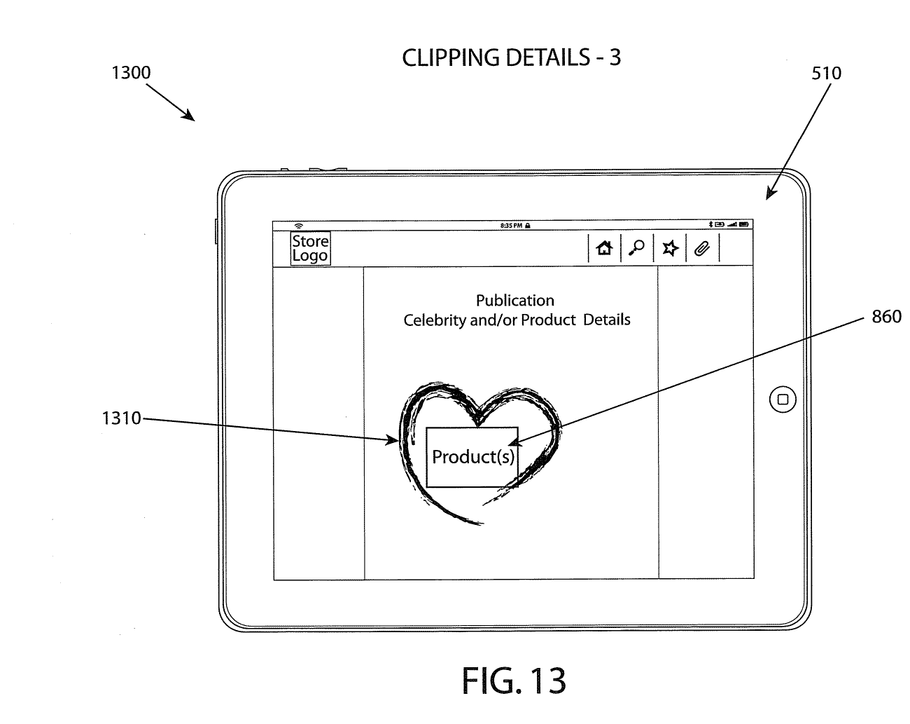

Selecting any of the search results (for example, 810 through 860 in FIG. 8; and 1010 through 1060 in FIG. 10) results in the selected search result being displayed in a standalone fashion within the app 640. FIGS. 11 through 13 display exemplary embodiments of several products 108 which have been selected from the search results page for further display. In the product display pages 1100 (FIG. 11), 1200 (FIG. 12), and 1300 (FIG. 13), the source page image is displayed, along with the product type information 230, product manufacturer name 240, celebrity information 250, and magazine cover image 270 in column 490, all of which are optionally displayed in greater detail As with the search results screens 800 and 1000, providing the product results on the source page images and supplementing with additional information regarding product 108 provides context for the user 695.

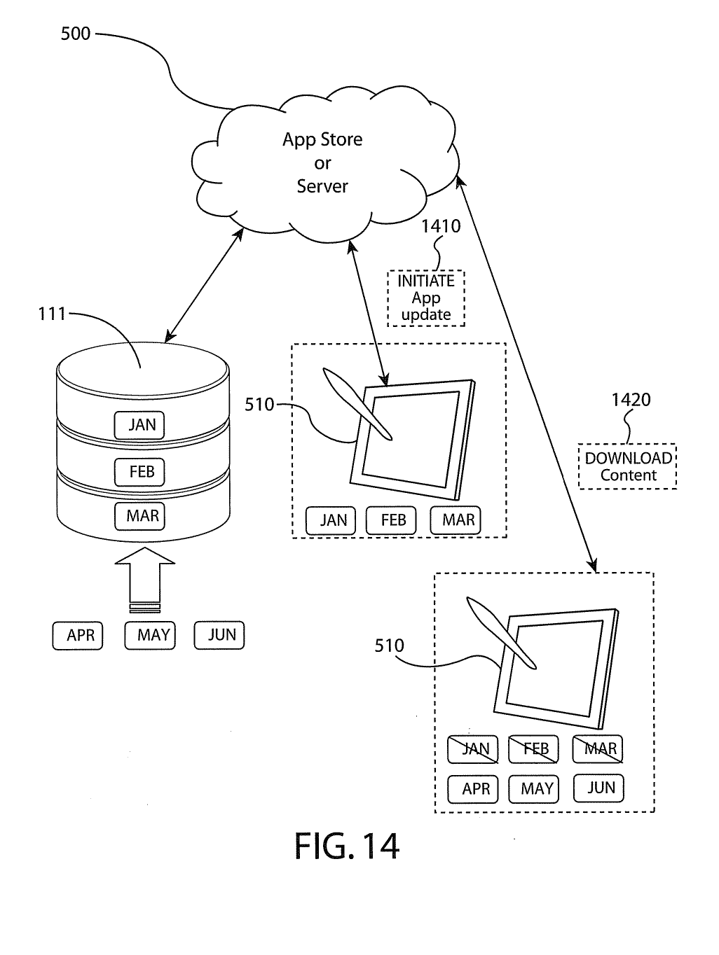

Reference will now be made to FIG. 14. New details about an existing product, or new products may be made available to the database 111 on a periodic basis. To illustrate, with reference to FIG. 14, at a given time, database 111 and portable computing device 510 are in synchronization with each other with data from months January, February, and March being up to date on both 111 and 510. If new product data or updated product data from the months of April, May and June is used to update database 111, portable computing device 510 will require an update to its data. Therefore, at 1410, portable computing device 510 requests new and/or updated information from database 111. In response, at 1420, the new information is transmitted to portable computing device 510 where it is downloaded and made available to app 640. As with the initial update of information on the portable computing device 510, at 1410, a request for the new and/or updated information in database 111 is sent from the portable computing device 510 to an application store (e.g. Apple® App Store) or a web server 500. In one exemplary embodiment, the new and/or updated information in database 111 is uploaded to the store/server 500 prior to said request 1410. In another embodiment, the new and/or updated information in database 111 is uploaded to the store/server after said request 1410. Once the store/server 500 receives the request 1410 for new and/or updated information, at step 1420 said information is extracted from either the store/server 500 (in instances where store/server 500 is updated prior to request) or from the database 111 through the store/server 500 (in instances where store/server 500 is updated after request) and passed back to the portable computing device 510 and the product display app 640. Once the requested new and/or updated information is populated in the portable computing device 510 and the product display app 640, it is then ready to be viewed through the product display app 640. Although in above the exemplary embodiment, the new and/or updated information in database 111 is updated and made available in sets of months, said information may be updated and made available in any units of time without deviating from the spirit of the invention. For example, information may be updated daily, weekly, monthly, quarterly, or annually, and made available in sets of days, weeks, months, quarters, or years.

The above description of specific embodiments has been given by way of example. From the disclosure given, those skilled in the art will not only understand the general inventive concepts and attendant advantages, but will also find apparent various changes and modifications to the structures and methods disclosed. For example, although the embodiments disclosed herein have been primarily directed to a portable computing device, the general inventive concepts could be readily extended to a personal computer (PC) or other relatively fixed console computers, and may be pursued with reference to a website and/or other online or offline mechanisms. It is sought, therefore, to cover all such changes and modifications as fall within the spirit and scope of the general inventive concepts, as described and claimed herein, and equivalents thereof.

1. A computer-implemented product information aggregation method from product sources, comprising the steps of:
receiving from a user a selection of a product;
extracting at least one product detail of the user-selected product from a product source;
mapping the at least one product detail with a store that carries the product;
transmitting the product detail and the store information to a database that is connected to a computer network; and
identifying to the user in a store at which the product is offered for sale said at least one product detail.

2. The product information aggregation method of claim 1 wherein the product source is a magazine.

3. The product information aggregation method of claim 1 wherein the product source is a web page.

4. The product information aggregation method of claim 1 wherein the product source is a printed material.

5. The product information aggregation method of claim 1 wherein the product source is a video.

6. The product information aggregation method of claim 1 wherein the product detail is an image.

7. The product information aggregation method of claim 1 wherein the product detail is the name of the product source.

8. The product information aggregation method of claim 1 wherein the product detail is the name of manufacturer of the selected product.

9. The product information aggregation method of claim 1 wherein the product detail is a category type of the selected product.

10. The method of claim 1 wherein the product detail is the name of a celebrity associated with the selected product.

11. A non-transitory computer readable storage medium having stored thereon executable instructions for displaying products, wherein the executable instructions are configured to be executed on a portable computing device to carry out a method comprising:
providing a search form to a user, wherein the search form is hosted on the portable computing device connected to a computer network, and wherein the search form includes a selection prompt for at least one category, and wherein said category comprises one of a publication, a product, a manufacturer, or a celebrity;
receiving a response to the selection prompt from the user through the portable computing device; and
providing the user with a search result corresponding to the response to the selection prompt, the search result being displayed on the portable computing device and relating to the product.

12. The non-transitory computer readable storage medium of claim 11 wherein the search result is an image.

13. The non-transitory computer readable storage medium of claim 11 wherein the search result is the name of the publication.

14. The non-transitory computer readable storage medium of claim 11 wherein the search result is the name of the manufacturer.

15. The non-transitory computer readable storage medium of claim 11 wherein the search result is a category type of the selected product.

16. The non-transitory computer readable storage medium of claim 11 wherein the search result is the name of the celebrity associated with the selected product.

17. The non-transitory computer readable storage medium of claim 11 wherein the search result is a brand name.

18. The non-transitory computer readable storage medium of claim 11 wherein the search result is the publication's publication date.

19. The non-transitory computer readable storage medium of claim 11 wherein the category further comprises an indicator that represents products identified as new products in the portable computing device.

20. A product information storage and retrieval system comprising:
a processor, wherein the processor is disposed on a portable computing device;
a server;
a database, the database comprising product detail information on at least one product; and
a memory storing instructions that, when executed, cause the portable computing device to:
via the server, synchronize the portable computing device with the product detail information in the database;
prompt the portable computing device to request updated product detail information from the database via the server;
in response to the prompt, receive updated product detail information from the database via the server, and update the portable computing device with the updated product detail information;
prompt a user for selection of at least one product category value via a search form;
receive a response to the selection prompt from the user through the portable computing device; and
provide the user with a search result corresponding to the response to the selection prompt, the search result being displayed on the portable computing device, wherein the search result comprises a celebrity and an endorsed product.
